(19) United States
(12) Patent Application Publication
(10) Pub. No.: US 2004/0174826 A1
(43) Pub. Date: Sep. 9, 2004

(54) Method and apparatus for minimizing dense mode multicast flooding between a local area network switch and a router

(76) Inventors: George Popovich, Palatine, IL (US); Michael F. Korus, Eden Prairie, MN (US); Vidya Narayanan, Schaumburg, IL (US)

Correspondence Address: WELSH & KATZ, LTD, 120 S RIVERSIDE PLAZA, 22ND FLOOR, CHICAGO, IL, 60606, US

(21) Appl. No.: 10/329,584

(22) Filed: Dec. 26, 2002

(51) Int. Cl. H04L 12/28

(52) U.S. Cl. 370/254

(57) ABSTRACT

A method and apparatus are provided for minimizing dense mode multicast flooding between a local area network (“LAN”) switch and a multicast capable router. The method includes the steps of detecting a prune message from the multicast capable router, identifying a multicast group from the prune message and setting a flag within the LAN switch to disable transfer of multicast datagrams of the determined multicast group to the multicast capable router. The apparatus can include a software interface, a control information processor, and an Internet switch-memory.

### FIELD OF THE INVENTION

The field of the invention relates to the Internet, and more particularly to multicast messaging.

### BACKGROUND OF THE INVENTION

Multicast messaging over the Internet is generally known. Multicast (often referred to as “IP multicast”) is a routing technique that allows Internet Protocol (IP) traffic to be sent from one source or multiple sources and delivered to multiple destinations. As opposed to sending individual packets to each destination, a single packet may be sent to a multicast group, which is identified by a single IP destination group address.

Multicast groups may be formed and maintained using the Internet Group-Membership Protocol (IGMP). IGMP may be used to dynamically register individual hosts in a multicast group with a particular Class D address as defined by RFC 1112 from the Internet Engineering Task Force (IETF). Hosts announce group memberships on startup by transmitting IGMP messages to nearby routers. Routers listen for IGMP messages and periodically send out queries to discover which groups are active or inactive on particular networks.

A number of multicast routing protocols are available to be used to build routing tables for each multicast group. Protocol-Independent Multicast (PIM) is one such protocol. PIM may operate under either of two modes. One mode is referred to as “dense mode” for large numbers of receivers (“densely” populated groups) and the other mode is referred to as “sparse mode” for fewer or geographically co-located receivers (“sparsely” populated groups).

The PIM sparse mode relies upon registration of individual hosts to build multicast trees with interconnecting routers. Sparse mode is optimized for internet works with many data streams but relatively few receivers (or members). Sparse mode defines a rendezvous point that is then used as a registration point to facilitate the proper routing of packets.

PIM dense mode identifies group members by flooding the system with data streams. Branches with no members then initiate a process referred to as “pruning” to remove themselves from the path of future transmissions. Pruning occurs backwards from the hosts through connected routers. Whenever a router finds that it does not serve any group members, it sends a pruning message to an upstream source of the message(s), thereby pruning itself from the distribution tree.

While PIM dense mode works well, the pruning function does not function very well where flooding occurs through a local area network (LAN). Accordingly, a need exists for a method of controlling pruning of multicast messages that accommodates the presence of a LAN.

### BRIEF DESCRIPTION OF THE FIGURES

A preferred embodiment of the invention is now described, by way of example only, with reference to the accompanying figures in which:

FIG. 1 is a block diagram of a multicast system in accordance with an illustrated embodiment of the invention; and

FIG. 2 is a block diagram of an Ethernet switch and multicast capable router that may be used by the system of FIG. 1.

### DETAILED DESCRIPTION OF THE INVENTION

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements. A detailed description of the preferred embodiment and best modes for practicing the invention are described herein.

An improved method and apparatus are provided for minimizing dense mode multicast flooding between a local area network (“LAN”) switch (e.g., an Ethernet switch) and a multicast capable router. The improved method includes the steps of detecting a prune message from a connected multicast capable router, identifying a message group from the prune message and setting a flag within the Ethernet switch to disable transfer of multicast messages of the determined message group to the multicast capable router. The improved apparatus can include a software interface, a control information processor, and an Internet switch memory. A more detailed explanation of the invention is provided in the following description and appended claims taken in conjunction with the accompanying drawings.

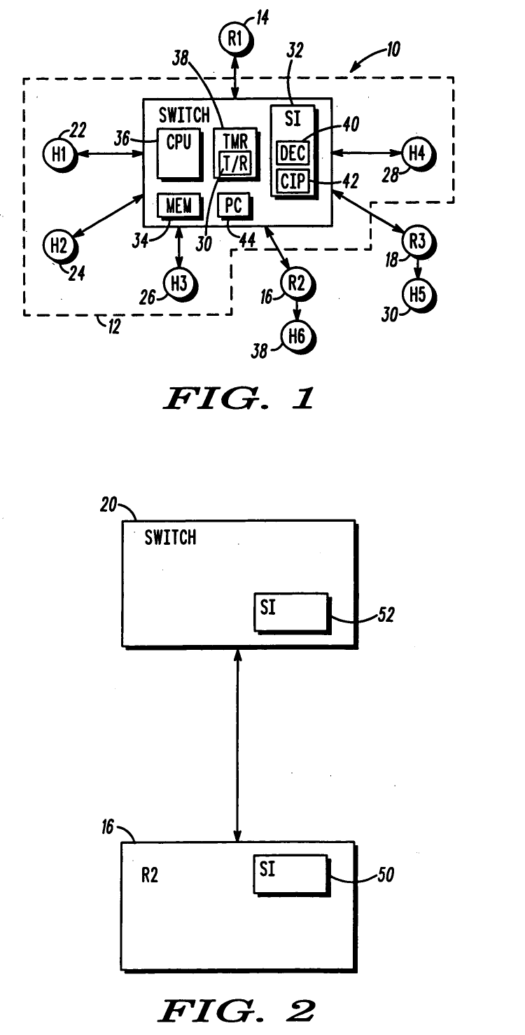

FIG. 1 is a block diagram of a portion of a multicast messaging system shown generally in accordance with an illustrated embodiment of the invention. The system may be used to provide a multicasting environment that allows any of a number of hosts to receive information from another host.

As shown, the hosts 22, 24, 26, 28, 30, 38 may form multicast groups as described in RFC 1112 from the IETF. In addition, multicast groups routing tables may be developed as generally provided under the PIM, dense mode process.

FIG. 1 shows a multicast system with three multicast capable routers 14, 16, 18 coupled to a LAN 12. Within the LAN 12, the routers 14, 16, 18 are coupled to a layer 2 Ethernet switch 20.

As would be known to those of skill in the art, the routers 14, 16, 18 communicate on a layer 3 format. Since the Ethernet switch 20 operates on a layer 2, layer 3 control transmissions between the routers 14, 16, 18 are not generally available to the router 20. Stated another way, the Ethernet switch 20 is transparent to the routers 14, 16, 18. Since layer 3 control transmissions between routers 14, 16, 18 are not available to the Ethernet switch 20, it has not been possible under the prior art to prune multicast flows to individual routers within the switch 20.

As an example of an illustrated embodiment of the invention, it will be assumed that a particular IP multicast address within the IPv4 Class D address space identifies a particular set of IP hosts H1 22, H2 24, H4 28, H5 30 interested in receiving multicast traffic designated for that group. For purposes of explanation, it will be assumed that router R1 14 is the multicast source for the discussion that follows. It may also be assumed that the switch 20 is capable of IGMP snooping for purposes of building a multicast table of multicast groups for hosts H1 22, H2 24, H3 26 and H4 28.

For purposes of this example, it may be assumed that hosts H1 22, H2 24 and H4 28 have sent IGMP messages to their local multicast router R1 14 to join the particular multicast group mentioned above. It may also be assumed that host H5 30 has sent an IGMP message to router R2 18. Using IGMP snooping, the switch 20 may create a multicast routing table for members of the group within the LAN 12 including hosts H1 22, H2 24 and H4 28.

Under PIM, dense mode, the router R1 14 periodically reverts to flooding the LAN 10 and downstream routers 16, 18 with multicast datagrams. Routers that have no downstream members with an interest in the multicast datagrams prune back the unwanted traffic.

Routers 14, 16, 18 accumulate state information by receiving data streams through the flood and prune mechanism. These data streams contain the source and group information that the routers use for creation of their multicast routing tables.

When the router R1 14 floods the LAN 12, the switch 12 automatically forwards the datagrams to any connected router 16, 18. For purposes of explanation, it will be assumed that the flooded multicast datagrams are directed to a multicast group including hosts H1 22, H2 24, H4 28 and H5 30.

Since router R3 18 has a host 30 that is within the group, router R3 does not attempt to prune back the flow. Router R2 16, however, does not have a host that is part of the multicast group. Therefore router R2 16 composes a prune message in accordance with the layer 3 protocol and sends the message towards the source (in this case through switch 20 to router R1 14). Since the switch 20 operates at layer 2, the prune message passes through the switch 20 and is received by the router R1 14.

Router R1, however, cannot prune back the flow through the LAN 12 because to do so would also cut off the data flow through router R3 18 to host 30. As such, the prune message from router R2 16 to router R1 14 is ineffective.

To solve this problem, the present invention provides a system 10 that extends the functionality of pruning to the LAN 12. In this regard, a software interface (SI) module 32 is provided within the switch 20. A decoder 40 within the software interface module 32 may function to monitor and decode the layer 3 control information passing through the switch 20 for pruning information.

Once a prune message is detected, a control information processor 42 within the SI module 32 determines an identity (or port) of the router R2 16 sending the message and an identity of the multicast group involved. Once the pruning information is collected, it may be stored in a memory 34 as a flag for later use.

When the switch 20 subsequently receives multicast datagrams, a central processing unit (CPU) 36 within the switch 20 compares the destination group identifier of the datagram with the previously detected and stored pruning information. When a match is found, the CPU 36 discards any multicast datagram that otherwise would have gone to the router originating the detected pruning information.

The discarding of the multicast datagram may be accomplished under any of a number of methods. For example, Ethernet switches 12, by their very nature, are programmed to forward any received multicast datagrams to any connected downstream routers. Deletion of datagrams to pruned groups may be accomplished by placing a conditional nulling subroutine in a programming tree of the Ethernet switch 20 ahead of the transfer command that forwards the datagrams to the router 16.

Under another embodiment, a pair of SI modules 50, 52 as shown in FIG. 2, replaces the SI module 32 of FIG. 1. The first SI module 50 may reside in the router R2 16 and receive information (e.g., a multicast group identifier) directly from the pruning function of the IP multicast routing protocol already present within the router 16. The SI module 50 functions to form a layer 2 link with the second SI module 52 within the switch 20 for purposes of blocking any further multicast datagrams from the identified group.

Once the first SI module 50 receives a group identifier from the pruning application within the router 16, the module 50 composes a message packet including at least the group identifier and identifier of the router 16. The message may then be transferred to the second SI module 42. Within the second SI module 52, the group identifier and router identifier is decoded from the packet and processed by the CPU 36 as discussed above.

In another embodiment of the invention, a timer 38 may be activated each time a group identifier is stored in memory 34. After a predetermined time period (e.g., 3 minutes), the timer 38 times out and a timer reset 39 deletes the corresponding group identifier from the memory 34. The use of the timer 38 allows any new routers added to the system since the last time-out to receive multicast datagrams from an active source.

In yet another embodiment of the invention, the SI modules 32, 40, 42 may monitor switch connections for messages indicating that a new multicast group member has been added to the system. Upon detecting the presence of a new multicast group member, the SI modules 32, 40, 42 operating through a prune control 44 may delete any pruning entries for the router through which the new group member was detected.

The deletion of pruning information in the path to the new group member allows the new group member to receive and process any multicast datagrams. If the new group member should then determine that it has no interest in the multicast datagrams, the new group member may then prune back the flow as described above.

As specific embodiments of a method and apparatus for blocking multicast flooding according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments and examples described. Therefore, it is contemplated to cover the present invention, any and all modifications, variations, or equivalents that fall within the true spirit and scope of the basic underlying principles disclosed and claimed herein.

We claim:

1. A method of minimizing dense mode multicast flooding between a local area network (“LAN”) switch and a multicast capable router, such method comprising the steps of:
detecting a prune message from the multicast capable router;
identifying a multicast group from the prune message; and
setting a flag within the LAN switch to disable transfer of multicast datagrams of the determined multicast group to the multicast capable router.

2. The method of minimizing dense mode multicast flooding as in claim 1 wherein the step of detecting the prune message further comprises decoding the prune message within the LAN switch in accordance with a layer three protocol.

3. The method of minimizing dense mode multicast flooding as in claim 2 wherein the step of detecting the prune message further comprises receiving the prune message from a pruning function within the multicast capable router.

4. The method of minimizing dense mode multicast flooding as in claim 3 further comprising transferring the detected prune message from the multicast capable router to the LAN switch.

5. The method of minimizing dense mode multicast flooding as in claim 1 wherein the step of setting a flag further comprises storing an identifier of the multicast group and an identifier of the multicast capable router.

6. The method of minimizing dense mode multicast flooding as in claim 5 wherein the step of storing the identifier of the multicast capable router further comprises storing a port identifier of the LAN switch.

7. The method of minimizing dense mode multicast flooding as in claim 1 further comprising activating a timer when the flag is set.

8. The method of minimizing dense mode multicast flooding as in claim 7 further comprising clearing the flag when the activated timer exceeds a threshold.

9. The method of minimizing dense mode multicast flooding as in claim 1 further comprising detecting group membership of a host through the multicast capable router.

10. The method of minimizing dense mode multicast flooding as in claim 9 further comprising clearing the flag upon detection of group membership of the host through the multicast capable router.

11. An apparatus for minimizing dense mode multicast flooding between a local area network (“LAN”) switch and a multicast capable router, such apparatus comprising:
means for detecting a prune message from the multicast capable router;
means for identifying a multicast group from the prune message; and
means for setting a flag within the LAN switch to disable transfer of multicast datagrams of the determined multicast group to the multicast capable router.

12. The apparatus for minimizing dense mode multicast flooding as in claim 11 wherein the means for detecting the prune message further comprises means for decoding the prune message within the LAN switch in accordance with a layer three protocol.

13. The apparatus for minimizing dense mode multicast flooding as in claim 12 wherein the means for detecting the prune message further comprises means for receiving the prune message from a pruning function within the multicast capable router.

14. The apparatus for minimizing dense mode multicast flooding as in claim 13 further comprising means for transferring the detected prune message from the multicast capable router to the LAN switch.

15. The apparatus for minimizing dense mode multicast flooding as in claim 11 wherein the means for setting a flag further comprises means for storing an identifier of the multicast group and an identifier of the multicast capable router.

16. The apparatus for minimizing dense mode multicast flooding as in claim wherein the means for storing the identifier of the multicast capable router further comprises means for storing a port identifier of the LAN switch.

17. The apparatus for minimizing dense mode multicast flooding as in claim 11 further comprising means for activating a timer when the flag is set.

18. The apparatus for minimizing dense mode multicast flooding as in claim 17 further comprising means for clearing the flag when the activated timer exceeds a threshold.

19. The apparatus for minimizing dense mode multicast flooding as in claim 11 further comprising means for detecting group membership of a host through the multicast capable router.

20. The apparatus for minimizing dense mode multicast flooding as in claim 19 further comprising means for clearing the flag upon detection of registration of the host through the multicast capable router.

21. An apparatus for minimizing dense mode multicast flooding between a local area network (“LAN”) switch and a multicast capable router, such apparatus comprising:
a software interface adapted to detect a prune message from the multicast capable router;
a control information processor adapted to identify a multicast group from the prune message; and
a memory within the LAN switch for storing a multicast group and identifier of the multicast capable router to disable transfer of multicast datagrams of the determined multicast group to the multicast capable router.

22. The apparatus for minimizing dense mode multicast flooding as in claim 21 wherein the software interface further comprises a decoder adapted to decode the prune message within the LAN switch in accordance with a layer three protocol.

23. The apparatus for minimizing dense mode multicast flooding as in claim 22 wherein the software interface further comprises a first application within the multicast capable router and a second application within the LAN switch.

24. The apparatus for minimizing dense mode multicast flooding as in claim 21 further comprising a timer that is activated when the flag is set.

25. The apparatus for minimizing dense mode multicast flooding as in claim 24 further comprising a timer reset adapted to clear the flag when the activated timer exceeds a threshold.

26. The apparatus for minimizing dense mode multicast flooding as in claim 21 further comprising a switch connection adapted to detect group membership of a host through the multicast capable router.

27. The apparatus for minimizing dense mode multicast flooding as in claim 26 further comprising a prune control adapted to clear the flag upon detection of registration of the host through the multicast capable router.

28. A method of minimizing dense mode multicast flooding between a local area network (“LAN”) switch and a multicast capable router, such method comprising the steps of:
detecting a layer three prune message within the LAN switch from a multicast capable router;
identifying a multicast group from the layer three prune message; and
setting a flag to disable transfer of multicast datagrams of the determined multicast group to the multicast capable router.

29. The method of minimizing dense mode multicast flooding as in claim 28 further comprising flooding the connected multicast capable router with multicast datagrams from the multicast group from the LAN switch until the layer three prune message is received.

30. The method of minimizing dense mode multicast flooding as in claim 28 further comprising activating a timer when the layer three prune message is detected.

31. The method of minimizing dense mode multicast flooding as in claim 30 further comprising clearing the flag when the activated timer exceeds a threshold.

32. The method of minimizing dense mode multicast flooding as in claim 28 further comprising detecting registration of a host through the multicast capable router.

33. The method of minimizing dense mode multicast flooding as in claim 32 further comprising clearing the flag upon detection of registration of the host through the multicast capable router.
